(19) United States
(12) Patent Application Publication
(10) Pub. No.: US 2010/0126251 A1
(43) Pub. Date: May 27, 2010

(54) Hall Effect-Based Real-Time Lubrication Monitoring System Modes of Operation and Use Thereof

(75) Inventors: Nicholas D. PILEGGI, Winter Springs, FL (US); William T. Pippin, Orlando, FL (US); Michael G. Sunners, Winter Springs, FL (US)

Correspondence Address: MORGAN LEWIS & BOCKIUS LLP, 1111 PENNSYLVANIA AVENUE NW, WASHINGTON, DC, 20004, US

(73) Assignee: Micromem Technologies, Inc.

(21) Appl. No.: 12/624,140

(22) Filed: Nov. 23, 2009

Related U.S. Application Data
(60) Provisional application No. 61/118,056, filed on Nov. 26, 2008.

(51) Int. Cl. G01N 15/10; G01F 1/075; G01N 11/14; G01K 7/00; G01L 7/00

(52) U.S. Cl. 73/53.07; 73/861; 73/54.31; 374/163; 73/700

(57) ABSTRACT

The invention relates to a system for real-time monitoring of motile lubricants within the presently common reciprocating engine. A sensor array is fully submerged (or partially submerged) within the lubricant system fluid, for example, oil. The fluid property monitoring is accomplished by multiple sensors acting in unison to provide data to a remote processing and display portion of the system. The system allows for the unified data acquisition and real-time comparison by providing both a physical sensor unit with embedded multiple sensors of multiple types as well as multiple DSP (Digital Signal Processing) or microcontroller modules acting in parallel to provide best-fit results for purposes of real-time monitoring high-temperature motile lubricants for property degradation (namely viscosity and foreign particulate detection) and particulate accumulation.

This application claims the benefit of pending U.S. provisional patent application No. 61/118,056, which was filed on Nov. 26, 2008, and is incorporated herein by reference in its entirety.

### FIELD OF THE INVENTION

The invention encompasses embodiments related generally to automotive reciprocating engines, transmissions, and aircraft. Such closed systems require constant internal lubrication flow to protect the internal moving parts from the inherent friction. The lubricants are typically carbon-based or related synthetics, which over time vary or decay due to the system environment. The key component of the lubricant is the property of viscosity, which varies over time, temperature, and use. In such systems, particulates of metallic and non-metallic variety tend to accumulate over time and use. The present invention provides a real-time user notification system for early warning notification when conditions reach unfavorable levels that can result in damage to the system.

### BACKGROUND OF THE INVENTION

The field of endeavor is related to the automobile industry and in particular to engines and large scale mechanical devices, which utilize motile lubricating fluids in high-temperature environments in which real-time monitoring of the changing fluid properties as well as the detection of metallic particulates would be beneficial. Existing systems have two main problems influencing the implementation of such a solution. First, the environmental temperatures are often in excess of 150 degrees Celsius. These temperature extremes require that special concerns be addressed for the use of various electronic sensors and electrically active elements to support those sensors. The temperature extremes are such that many times no viable solution exists. Second, a sensor that is continually and fully submerged (or partially submerged) within the high-temperature lubricants is desired. However, the temperature and the properties of the liquids make it difficult to protect a sensor or sensor array from degradation.

To monitor engine oil properties, the following data points are needed: temperature of lubricant, absolute pressure, and viscosity. Viscosity describes a fluid's internal resistance to flow and may be thought of as a measure of fluid friction. The invention uses thermocouples and common pressure sensors to acquire the data points since viscosity is a function of temperature and pressure, which are properties that define the behavior of a fluid. In addition to detecting these data points, it is critical to detect metallic particles, which can damage critical moving parts. Accordingly, the invention also uses a simple magnet and an associated Hall sensor to attract and detect metallic particles that may be present in the fluid. An added or optional feature of the detection method may include inductive coils that are incorporated into the design to generate electrical signals that can also be affected by the presence of moving metallic particles.

Monitoring viscosity requires a method of creating a signal substantially related to the fluidic friction of the engine lubricant. The invention fulfills this requirement with a simple method that includes placing two GaAs Hall-based sensor elements within the fluidic lubricant in such locations where the fluid is flowing and not stagnant when in use. These GaAs Hall-based sensor elements are substantially similar and located in close proximity to one another within a flow path of the lubricant. With such a configuration, many issues that can generate errors in data collection can be ignored for purposes of simplifying related mathematics and decreasing overall production costs. According to one embodiment of the invention, there is one difference between the two GaAs Hall-based sensor elements. That difference is in the shapes of the sensor elements. In one embodiment, one sensor element has a rotor with teeth substantially like those found in a paddle wheel or gear. The rotor with teeth rotates when appropriately placed within the lubricant flow path in a manner substantially related to the velocity of the lubricant. The viscosity of the lubricant has a negligible effect on the rotation of the rotor with teeth. The other sensor element has a substantially smooth rotor that rotates in a similar fashion as the rotor with teeth. Due to the different (smooth) shape of the rotor, the rotational rate of the smooth rotor is substantially affected by the friction of the fluid, which is directly related to the lubricant viscosity. The rotors of the two sensor elements rotate at different velocities and thus generate electrical signals that their associated GaAs Hall sensors detect due to magnetic field variations. The difference between these two signals is related to the lubricant viscosity. The rotor with teeth will always spin faster than the toothless rotor due primarily to the different effects of the fluidic friction (viscosity) on the rotors. Plotting this difference along with the local temperature and pressure and comparing these plots against documented lubricant viscosity tables show that the two provide substantially similar results. Due to slight errors in conversion, the difference should be substantially linear and thus allow for this simplistic design to create a useful manner of plotting viscosity with an electrical simplistic design and for reduced manufacturing complexity and cost.

Due to environmental factors, namely temperature, the sensor components located within the engine lubricant must be able to withstand conditions that are, at present, technically difficult to withstand. The invention employs sensor components that are robust under such conditions. For example, one embodiment of the invention uses thermocouples that measure temperature, pressure sense elements that are based on thick film resistor design, and Hall sensors. The Hall sensors are GaAs-based and thus have properties that allow the sensors to withstand high-temperature environments. Such elements have shown that they can function within this extreme environment in such a manner as to relate useful data. One embodiment of the invention utilizes moving mechanical parts to create signals related to fluidic velocity and viscosity. At present, such method proves effective and provides a simple solution. However, the invention is not limited to this method. GaAs Hall-based fluidic viscosity and velocity signals can be created without moving parts and could also be utilized within the scope of the invention.

### SUMMARY

The present invention provides for the real-time monitoring of flowing fluids associated with closed high-temperature environments present within or associated with internal combustion engines. One embodiment of the invention monitors flowing oil-based lubricants normally used with internal combustion engines for purposes of lubrication. Another embodiment of the invention monitors related application fluids, such as transmission fluids and glycerin-based coolants, such as anti-freeze. One aspect of the invention involves monitoring, in real time, the degradation of the monitored motile fluid due to heat, pressure, and mechanical means. Another aspect of the invention involves the detection of the presence of known harmful particulates, such as metal, within the lubricant monitored. Another aspect of the invention involves fluid monitoring with a sensor module that is continually and fully submerged or partially submerged within the lubrication fluid. The present invention addresses problems in the prior art that arise from several properties related to the environment, such as high heat and temperature constraints.

### BRIEF DESCRIPTION OF THE DRAWINGS

FIG. 1 is a schematic view of a real-time in-engine lubrication system according to one embodiment of the invention.

FIG. 2 is a block diagram of an in-engine lubricant sensor assembly according to one embodiment of the invention.

FIG. 3 is a block diagram of a display and processing portion of a system according to one embodiment of the invention.

FIG. 4 is a block diagram of DSP modules incorporated within a display and processing portion of a system according to one embodiment of the invention.

FIG. 5 is a schematic view of both a viscosity sensor and a velocity sensor mounted within a sensor assembly according to one embodiment of the invention.

FIG. 6 is a schematic view of both a viscosity sensor and a velocity sensor according to one embodiment of the invention.

FIG. 7 is a Fluidic Velocity and Viscosity Sensor Element Output Generalized in both graphic and equation format.

### DETAILED DESCRIPTION OF THE EMBODIMENTS

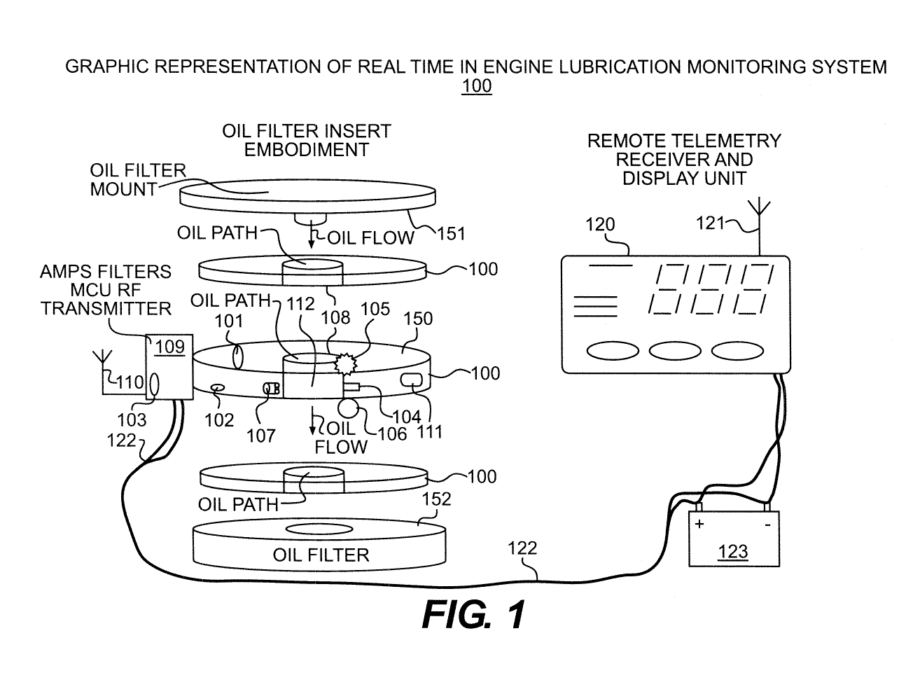

The exemplary embodiment shown in FIG. 1 comprises two main physical parts—the sensor element or assembly 100 and the display unit 120. Both parts comprise mechanical units and software/firmware elements working in concert to collect, process, and display the required data.

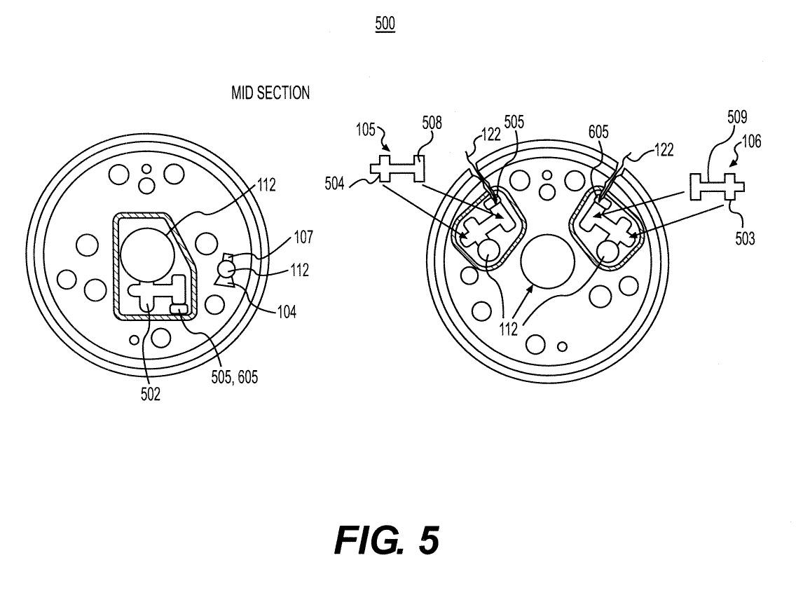

The sensor element 100 comprises several physical units and is designed to be installed within the associated engine or related mechanical device, which requires constant fluidic-based lubrication. According to one embodiment of the invention, the sensor element 100 comprises an overall form factor of that of a disc-shaped insert placed within the engine block and the oil filter. The sensor assembly 100 comprises a series of stacked discs 150, which allow for the physical manufacture of the complete assembly. One side of the sensor assembly 100 is designed to be mounted on the engine block 151 and provides inlet and outlet flow paths substantially similar to those already present in the attached oil filter, which is separated from the engine by the inserted sensor assembly 100. The opposite side of the sensor assembly 100 is designed to mate with the oil filter 152 in such a way as to substantially copy the features of the engine block that are normally attached to the oil filter. The sensor element 100 is positioned to allow lubricants moving to and from the oil filter to pass through the sensor element 100 so that the sensor element 100 has access to the moving fluid during the operation of the system to which the sensor element is attached. Elements 101, 104, 111, 105, 106, 102, and 107 must be submerged during operation. Element 101 is a bimetal thermocouple used to provide an electrical signal substantially related to the internal temperature of the lubricant fluid in which the sensor assembly 100 is submerged. This electrical signal is electrically coupled to electronic circuitry 109 of the sensor assembly 100. Element 111 is an absolute pressure sensor element electrically coupled to the electronic circuitry 109 and provides an electrical signal substantially related to the internal pressure of the lubricating fluid. Element 104 is a Hall sensor, which, in association with element 107, which is a magnet, creates an electrical signal substantially reflecting the presence of metallic particles passing between the magnet 107 and the Hall sensor 104. The Hall sensor 104 subsequently provides an electrically coupled signal to the electronic circuitry element 109. Element 102 is a bimetal thermocouple used to provide an electrical signal substantially related to the internal temperature of the lubricant fluid at a point closer to the external portion of the sensor assembly 100, which is submerged in the lubricant fluid. Thermocouple 102, in conjunction with thermocouple 101, generates differential temperature-based electric signals. Element 103 is a bimetal thermocouple used to provide an electrical signal substantially related to the external temperature of the sensor assembly 100. Thermocouple 103 can provide differential signals to thermocouples 101 and 102, as well as be used as a referent to both. Two inductive coils 108 are concentrically located around the bolt-shaped sensor assembly 100 for purposes of providing substantially inductive responsive electrical signals to the electronic circuitry 109 of the sensor assembly 100. Element 105 is a Hall-based fluid velocity sense element (FIG. 5) used to provide to the electronic circuitry 109 of the sensor assembly 100 an electrical signal substantially related to the fluidic lubricant's fluid velocity. Element 106 is a Hall-based fluid viscosity sense element (FIG. 5) used to provide to the electronic circuitry 109 of the sensor assembly 100 an electrical signal substantially related to the fluidic lubricant's fluid viscosity. Both sense elements 105 and 106 reside partially within and adjacent to a lubricant path channel 112. According to one embodiment of the invention, the lubricant channel 112 takes the form of a machined tunnel passing through the discs 150 of the sensor assembly 100. Also, within the flow path 112 is the magnetic source 107 and associated Hall sensor 104. According to this design, any ferrous metallic particles that are suspended within the lubricant are deposited in the flow path 112 in close proximity to magnet element 107. Thus, there is a higher probability that the Hall effect element 104 will be affected by those deposited metallic particles. The location of the magnet 107 and Hall sensor 104 is such that they help provide a collection point for these errant metallic materials in an attempt to reduce their travel back into the lubricant system being monitored.

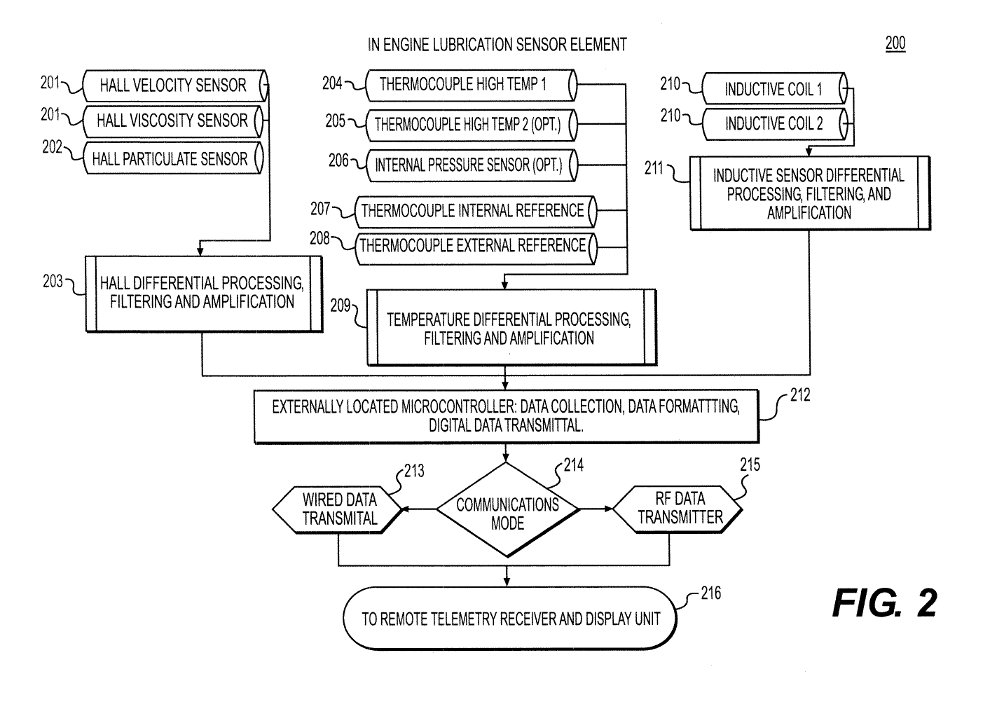

The electronic circuitry 109 of the sensor assembly 100 collects electrical data signals from the above-mentioned sense elements, draws its power from electrical conductors 122, and transmits its output electric signals via wired connection 122 or wireless communication means 110. The electrical circuitry 109 comprises common electronic signal amplification means, filtering means, and data transformation means. As shown in FIG. 2, data collection involves the collection of three types of data: Hall sensor data, temperature and pressure sensor data, and inductive sensor data. Signals from Hall velocity sensor element 105 and Hall viscosity sensor element 106 are represented by blocks 201. Signals from the Hall-based particulate detection element 104 is represented block 202. The electrical signals represented by blocks 201 and 202 are electrically manipulated to filter unwanted signals, such as noise, and amplified at block 203 to produce electrical signals compatible with subsequent processing. Block 204 represents the electrical signal generated by the innermost thermocouple 101. Block 205 represents signals from an optional thermocouple with characteristics substantially similar to those of element 101. The optional thermocouple can be used to provide additional information that may be required by a particular application. Block 206 represents the data provided by optional pressure sensor element 111. In general, pressure can be ignored since most internally lubricated systems maintain their internal pressure via other means and, in most cases, this makes pressure essentially become a constant for the purpose of subsequent calculations. Blocks 207 and 208 represent signals from the internal temperature reference thermocouple 102 and the external temperature reference thermocouple 103, respectively. The electrical signals represented by block elements 204, 205, 206, 207, and 208 are electrically manipulated to filter unwanted signals, such as noise, and amplified at block 209 to produce electrical signals compatible with subsequent processing. Signals from the two inductive coils 108 are represented by blocks 210. These electrical signals are electrically manipulated to filter unwanted signals, such as noise, and amplified at block 211 to produce electrical signals compatible with subsequent processing.

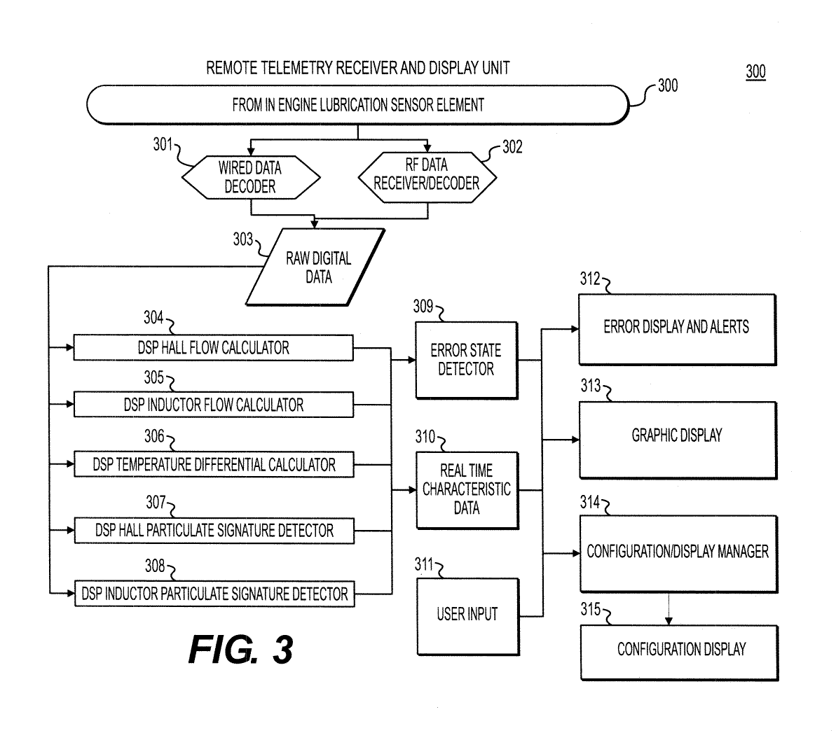

Block 212 represents an embedded microcontroller of the sensor assembly 100. At this block, the three data types are collected and formatted for transmittal to external elements. The data from the microcontroller 212 is then passed to the communications processing portion 214 of the circuitry and, based on whether wired data transmittal wireless data transport is required, data passes to block elements 215 or 213, respectively. At this point, the data passes from the sensor element 100 and into the display unit 120 of the system as depicted by block element 216. Further data processing is shown in FIG. 3.

Referring again to FIG. 1, the lubrication system display unit 120 is used to display data in a manner useful to the application. In general terms, there are three types of displays: errors and alerts, statistical parametric data display related to the individual sensed data points, and graphical user interfaces used to interact with the system user and thereby configure data display behaviors. The display unit 120 directly interacts with the reception antenna 121 and the wired power and data connection 122. Both the sensor element 100 and display unit 120 can receive power from battery element 123 or other useful power sources.

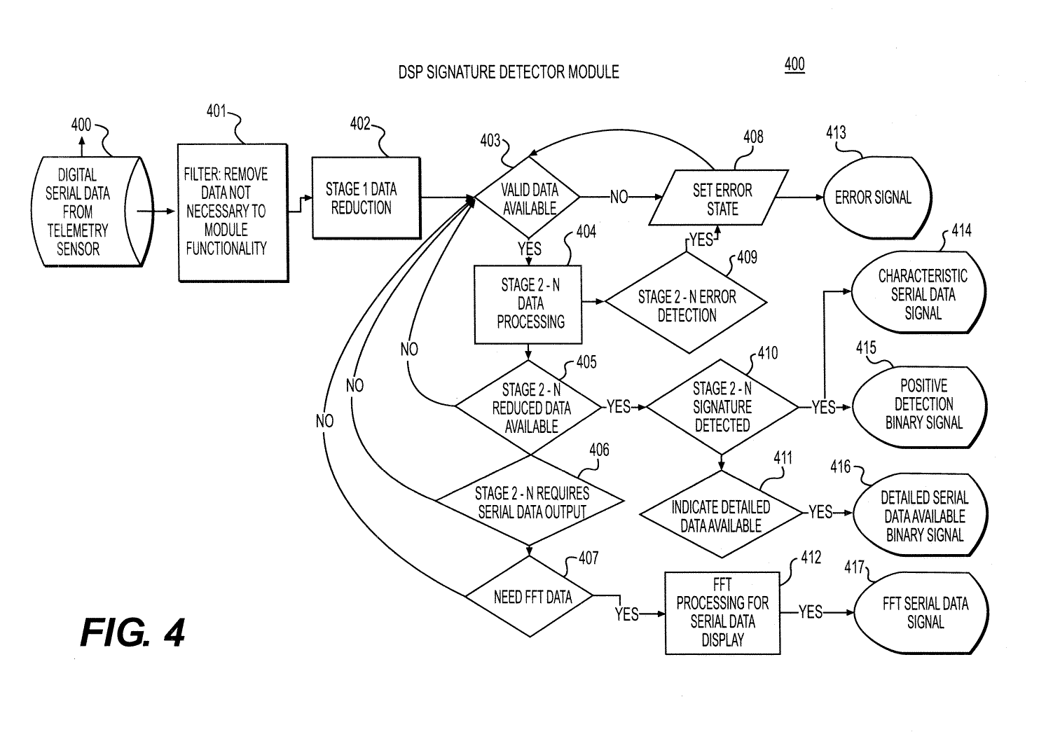

FIG. 3 depicts the electrical function and data manipulation of the display unit 120. Data enters the display unit 120 at block element 300. This data can be from either the wireless data source 121 or the wired means 122. Block elements 301 and 302 convert and manipulate incoming wired and wireless data, respectively, to produce signals that will be useful at block element 303. Block element represents the point at which raw data is formatted to be subsequently passed to DSP processing elements 304 through 308. As will be discussed in more detail below with reference to FIG. 4, these DSP elements handle their data the same way. DSP processing at blocks 304 through 308 is divided according to the type of data. Such parallel segregation allows for all data types to essentially generate the same kind of outputs, which can then be passed to block element 309 for purposes of detecting formalized errors and for purposes of real-time characterization at block element 310. The DSP Hall flow calculator 304 is responsible for decoding the data from sensors 105 and 106 and generating a digital signal directly reflecting the lubricant viscosity. DSP inductor flow calculator 305 takes data from coils 108 and generates a digital data signal directly related to the variations between the coils. DSP Temperature Differential Calculator 306 creates a digital output based on signals from temperature input elements 101, 102, 103 and pressure element 111. DSP Hall Particulate Signature Detector 307 creates a digital output based on the variations caused by metallic particles affecting Hall element 104. DSP Inductor Particulate Signature Detector 308 creates a digital output based on the variations caused by metallic particles affecting inductor elements 108.

The Error State Detector 309 receives signals, and those defined as errors are formatted and displayed at Error Display and Alerts 312. The errors include, but are not limited to, temperature under and over alerts, data missing errors, metallic particles detected, and DSP calculation errors. Real Time Characteristic Data 310 receives the detailed DSP digital data from DSP elements 304 through 308 and formats that data to produce useful displays and trend plots for display at Graphic Display 313. User input 311 is facilitated by push buttons and other means facilitated by the display unit 120. The inputs are used to adjust configurations and determine what displays are used at Configuration/Display Manager 314. Configuration at this point affects the type and form of the data displayed at the Configuration Display 315 as well as the displays 312 and 313. Error Display and Alerts 312 can comprise, for example, LED illumination, piezo sounders, or LCD displays. Graphic Display 313 can comprise, for example, trend plots showing various generated data points or simple numeric displays representing the resultant data. Data points available for display can include, but are not limited to, calculated viscosity, calculated fluid velocity, internal lubricant temperature and pressure, temperature variations, external temperature, differential temperature, particulate detection, and particulate signature decode representing detected metal types.

DSP elements 304-308 will now be described with reference to FIG. 4. Raw digital data from block 303 enters a particular DSP processor at block 400. Data is filtered at block 401 to retain only that data necessary for DSP. That data subsequently goes through stage 1 data reduction at block 402. At this point, data filtering and initial processing is accomplished for purposes of determining at block 403 if the data is valid. If the data is not valid, the appropriate error state flag at block 408 is set and an error signal is sent at block 413 for detection of the error at block 309. If data at element 403 is valid, it moves through Stage 2-N Data processing at block 404, where “N” represents multiple sequential stages of data processing. Once data is processed at block 404, errors local to the stage are checked at block 409. If errors are present, the process flow continues to block 408. If no errors occur, data continues to Stage 2-N Reduced Data Available at block 405. If no subsequent data is available, processing continues to block 403. If data is available, two paths are taken in parallel to Signature Detected 410 and to Requires Serial Data Output 406. If a signature is detected at block 410, a binary signal is set to indicate a positive detection binary signal at block 415. In parallel, Characteristic Serial Data Signal 414 is made available to the rest of the system. If detailed data is available at block 411, a detailed serial data available binary signal is set at block 416. If the stage at block 406 requires serial data to be output, the program flows to block 407. If there is no such requirement, the program flows to block 403. At block 407, if Fast Fourier Transformed data (FFT) is required, the program flows to block 412; otherwise, the program flow continues to block 403. FFT processing for the serial data display 412 formats and calculates the necessary data points to be passed to block 417 for subsequent display of that data to the user.

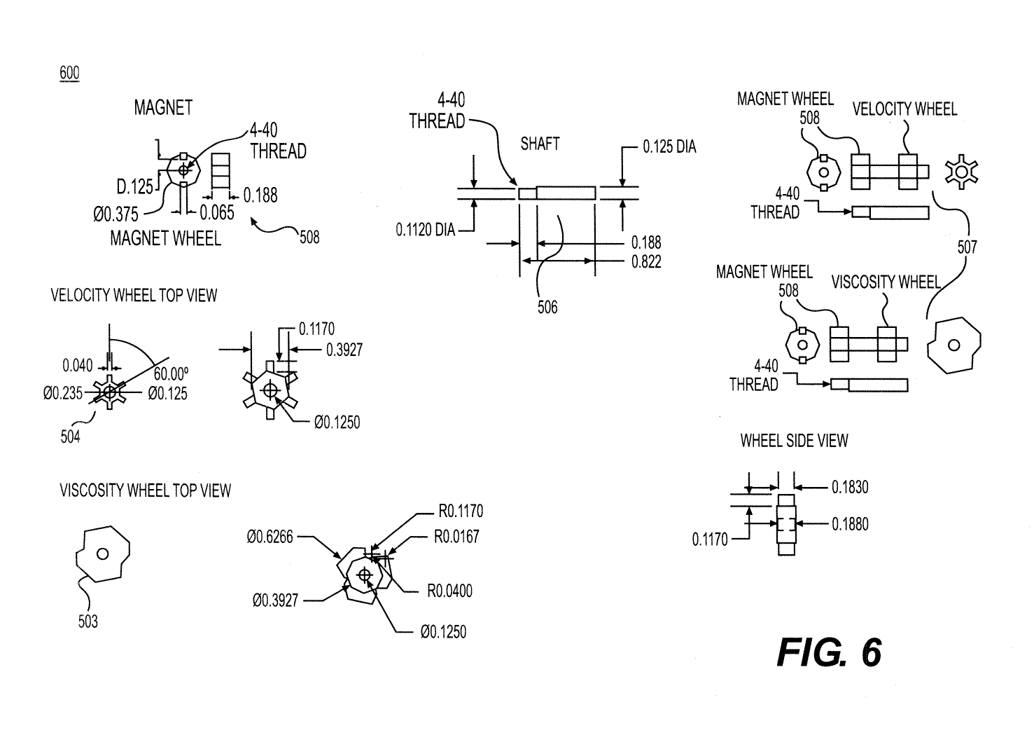

FIG. 5 shows a viscosity sensor 106 and a velocity sensor 105 in their physical proximity to an oil flow path 112 within the sensor element 100. FIG. 6 shows the detailed mechanical specifications for the two sensors according to the embodiment shown in FIG. 5. FIG. 5 shows the moving parts of the sensors 105 and 106 within their machined fixture. The exploded view shows an unpopulated machined fixture 502. The velocity and viscosity sensors 105 and 106 are substantially similar; the only difference between the two sensors 105 and 106 is the shape of the rotor that is exposed to the flowing lubricant. In the case of the viscosity sensor 106, the shape of the rotor 503 is of a substantially smooth design as shown in FIG. 6. For the velocity sensor 105, the rotor 504 has a shape like that of a paddle wheel. Each of sensors 105 and 106 comprises a wheel 508 with an imbedded magnet that is coupled via a cylindrical shaft 506 to the rotor. The sensors 105 and 106 are mounted within a mechanical recess 502 in such a manner so as to allow the viscosity and velocity rotors 503 and 504 to rotate in a manner substantially related to the flow of the fluid within path 112. The coupled assembly (sensors 105 and 106) is shown at 507 in FIG. 6. A metallic bushing 509 surrounds shaft 506 in such a manner so as to allow shaft 506 to freely rotate. Such rotation causes the magnet wheel 508 to move in alternating proximity to viscosity Hall sensor element 505 or velocity Hall sensor element 605 and thereby generate the related electrical signals that are eventually coupled via wire elements 122 to the electronic components of the overall system. According to one embodiment of the invention, the only allowed difference between the viscosity sensor and the velocity sensor is the shape of the fluid-submerged rotors (or wheels). The viscosity wheel 503 must be substantially smooth (i.e., no teeth-like protrusions) in comparison to the velocity geared wheel 504.

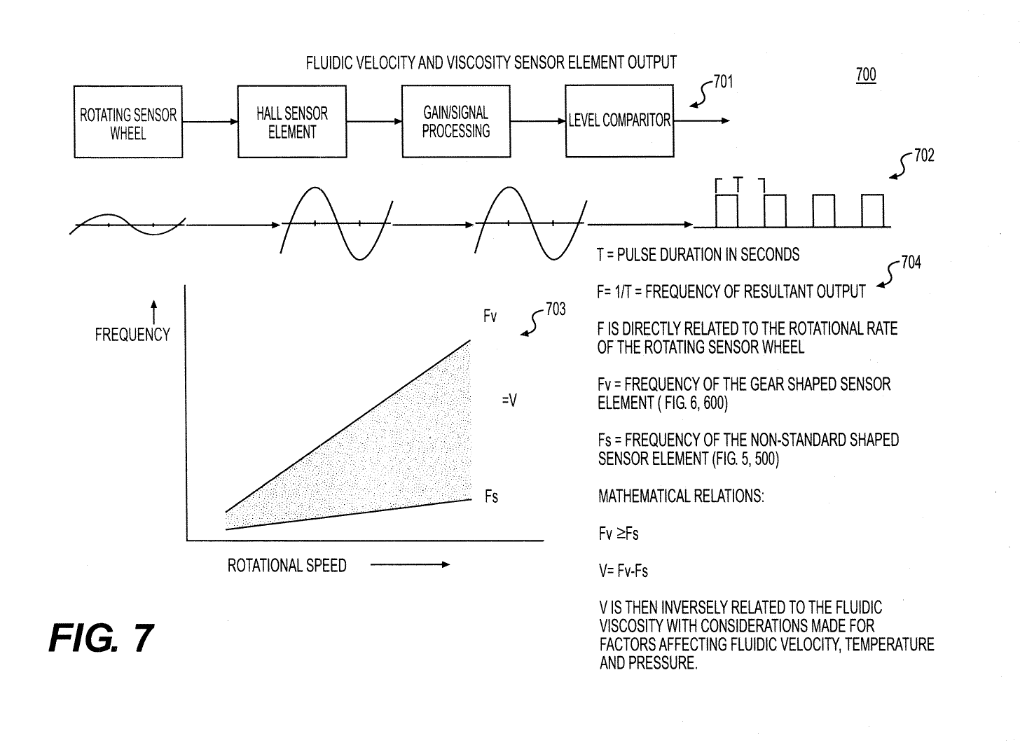

FIG. 7 illustrates the relations between the input and outputs of the Hall-based fluid velocity sensor 105 and the Hall-based fluid viscosity sensor 106. Block diagram 701 represents the process flow from the rotation of the sensor rotor or wheel to the finalized digital signal representing that rotation. Graphs 702 represent the idealized sinusoidal electrical signals associated with the elements of block diagram 701. The graph 703 represents the idealized relation between the output signals of the Hall-based velocity sensor 105 and those of the Hall-based viscosity sensor 106. The equation 704 generally represents the relationship between the velocity and viscosity data components. According to one embodiment, V=Fv−Fs. ‘V’ (calculated viscosity) is then inversely related to the fluidic viscosity with consideration for factors affecting fluidic velocity, temperature, and pressure. For this equation to be effective in relating the appropriate data, Fv must be greater than or equal to Fs. Fv is defined as the frequency of the gear-shaped sensor element. Fs is defined as the frequency of the non-standard-shaped sensor element. F is directly related to the rotational rate of the rotating sensor wheel and is defined as 1/T. T is the pulse duration in seconds of the output of the sensor elements as depicted at 702.

The foregoing description, for purposes of explanation, has been described with reference to exemplary embodiments. The illustrative discussions above are not intended to be exhaustive or to limit the invention to the precise forms disclosed. Many modifications and variations are possible in view of the above teachings. The exemplary embodiments were chosen and described in order to best explain the principles of the invention and its practical applications, to thereby enable others skilled in the art to best utilize the invention and various embodiments with various modifications as are suited to the particular use contemplated.

What is claimed is:

1. A system for monitoring properties of a high-temperature flowing lubricant, comprising:
an oil filter mount;
an in-engine lubricant sensor element comprising multiple sensors for sensing properties of the lubricant;
an oil filter;
a processing unit comprising data transmission means; and
a remote display;
wherein a lubricant flow path extends through the oil filter mount, the lubrication sensor element, and the oil filter; and
wherein the multiple sensors comprises a velocity sensor for sensing the velocity of the lubricant and viscosity sensor for sensing the viscosity of the lubricant.

2. The system of claim 1, wherein the velocity sensor comprises:
a velocity Hall-based sensor element; and
a velocity rotor connected to a first magnet wheel by a first shaft;
wherein the velocity rotor is in the lubricant flow path.

3. The system of claim 2, wherein the viscosity sensor comprises:
a viscosity Hall-based sensor element; and
a viscosity rotor connected to a second magnet wheel by a second shaft;
wherein the viscosity rotor is in the lubricant flow path.

4. The system of claim 3, wherein the shapes of the velocity rotor and the viscosity rotor are different.

5. The system of claim 4, wherein the shape of the velocity rotor has teeth.

6. The system of claim 5, wherein the shape of the viscosity rotor is smooth.

7. The system of claim 6, wherein the velocity Hall-based sensor element and the viscosity Hall-based sensor element generate electrical signals based on the rotations of the velocity rotor and the viscosity rotors.

8. The system of claim 7, wherein the electrical signals are transmitted from the lubricant sensor element to the display via the data transmission means.

9. The system of claim 8, wherein the velocity Hall-based sensor element and the viscosity Hall-based sensor elements are GaAs Hall-based sensor elements.

10. The system of claim 8, wherein the transmission means uses a wired connection.

11. The system of claim 8, wherein the transmission means uses a wireless connection.

12. The system of claim 8, wherein the multiple sensors further comprise at least one temperature sensor.

13. The system of claim 12, wherein the multiples sensors further comprise at least one pressure sensor.

14. The system of claim 8, wherein the multiple sensors further comprise a sensor for sensing foreign particles suspended in the lubricant.

15. The system of claim 14, wherein the sensor for sensing foreign particles includes a Hall-based sensor element and a magnet.

16. The system of claim 15, wherein the foreign particles are metallic.

17. The system of claim 8, wherein the velocity rotor is partially in the lubricant flow path.

18. The system of claim 8, wherein the velocity rotor is fully in the lubricant flow path.

19. The system of claim 8, wherein the viscosity rotor is partially in the lubricant flow path.

20. The system of claim 8, wherein the viscosity rotor is fully in the lubricant flow path.
